(19) United States
(12) Patent Application Publication
(10) Pub. No.: US 2005/0210097 A1
(43) Pub. Date: Sep. 22, 2005

(54) Method and system for managing programs for Web service system

(76) Inventors: Masahiro Himaki, Yokohama (JP); Isamu Adachi, Yokohama (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 10/964,627

(22) Filed: Oct. 15, 2004

(30) Foreign Application Priority Data
Mar. 3, 2004 (JP) 2004-058405

(51) Int. Cl. G06F 15/16

(52) U.S. Cl. 709/200

(57) ABSTRACT

A service processing method includes the steps of receiving a message including both a specification data for a service providing process and a progress information request for transmission of a historical information and a progress information, judging whether there is an information on a transmission of the historical information and the progress information, generating both the historical information and the progress information to be transmitted, and transmitting the generated historical information and the progress information. The data to be transmitted is generated when an information on transmission has been included in the received message. It then becomes possible to transmit both a historical information and a progress information within a restricted range.

### INCORPORATION BY REFERENCE

The present application claims priority from Japanese application JP2004-058405 filed on Mar. 3, 2004, the content of which is hereby incorporated by reference into this application.

### BACKGROUND OF THE INVENTION

The present invention is related to a service processing technique for executing process operations so as to provide predetermined services and thus for transmitting historical information and progress information.

In conventional Web services (namely, functions which are realized by executing programs and/or objects via Webs), information is transmitted and/or received among service processing apparatus while utilizing interfaces which have been previously determined among these service processing apparatus. Also, when both progress information and historical information of process operations for providing Web services are notified, specific interfaces among the service processing apparatus have been previously defined. It should be understood that technical ideas such as Web services are disclosed in Java Web Services” written by David A. Chappell et al., published by O'Reilly & Associates, Inc., March in 2002, pages 3-7.

### SUMMARY OF THE INVENTION

In the case that progress information, i.e; information on status of an operating program which has been used in processing of a service, and historical information, i.e; accumulated information on processing of service having been performed, are transmitted and/or received among a plurality of Web service processing apparatus, there are some possibilities that although the progress information and the historical information are required to be transmitted, a Web service processing apparatus functioning as a request source does not want to transmit the requested progress information and the requested historical information. In the interfaces which have been previously determined as to the notifications of the progress information and the historical information as explained in the above description, the following transmission control operation is desirable to be realized in the transmission-required Web service processing apparatus. That is, the transmission-required Web service processing apparatus may desirably control to transmit the progress information and the historical information by judging as to whether or not this transmission-required Web service processing apparatus may transmit the progress information and the historical information.

An object of the present invention is to provide such a technical idea. That is, in the case that both historical information and progress information acquired when a process operation for providing a predetermined service is carried out are transmitted, a transmission range thereof can be restricted to a specific transmission range.

A service processing apparatus, according to the present invention, is featured by such a service processing apparatus for executing a process operation for providing a predetermined service to transmit historical information and progress information, in which in such a case that transmission permission/non-permission information corresponding to information contained in progress information request data transmitted in combination with specification data of the predetermined service indicates that the notifications of both the historical information and the progress information are permitted, both the historical information and the progress information are transmitted to a progress information notification destination indicated in this progress information request data.

In the present invention, when the provision of the predetermined service (functions realized by executing program and object) is required, such a message is transmitted to a service processing apparatus (may be alternatively realized by computer, information processing apparatus, or program and object for executing such process operation) which executes this process operation. This message contains specification data used to execute the process operation for providing this service, and also, the progress information request data used to notify the historical information and the progress information of the process operation.

In the service processing apparatus of the present invention, when the message containing both the transmitted specification data and the transmitted progress information request data is received from a communication apparatus, such a process operation is performed in which this received message is stored in a storage apparatus, the specification is read out, and the predetermined service is provided based upon this specification data.

Therefore, the progress information request data is read to be analyzed from the message stored in the storage apparatus, the transmission permission/non-permission information corresponding to the information contained in the progress information request data is read out from the progress notification permission table stored in the storage apparatus, and then, a judgment is made as to whether or not the historical information and the progress information of the process operation are notified. For example, after such an information indicative of the progress information notification destination is read out from the progress information request data, the service processing apparatus refers to a service end point (information corresponding to notification destination of progress information) contained in the progress notification permission table, retrieves such a service end point which is made coincident with the read progress information notification destination, refers to an item of transmission permission/non-permission corresponding to this retrieved service end point, and makes the following judging operations. That is, if the value of the transmission permission/non-permission item indicates a transmission, then the transmission is permitted. If the value of the transmission permission/non-permission item is not a value indicative of the transmission, or if the coincident service end point cannot be retrieved, the transmission is not permitted. Other information than this service end point such as service detailed information, a certification, and a certification tree may be alternatively employed.

In such a case that the judgment is made that both the historical information and the progress information are notified, both historical information and progress information are produced on the storage means based upon the progress information request data, and then, both the produced historical information and the produced progress information are transmitted by the communication apparatus to a progress information notification destination indicated in the progress information request data.

As previously explained, in the present invention, when the historical information and the progress information are transmitted/received between the plural Web services, the service processing apparatus for providing the respective Web services are grouped based upon the service end points, the service detailed information, the certifications, and the certification tree. Then, since the progress notification permission table is employed in which the transmission permission/non-permission information has been set to the group, the range for transmitting the historical information and the progress information can be restricted.

According to the present invention, in the case that both the historical information and the progress information when the process operation for providing'the predetermined service is carried out are transmitted, this transmission range can be restricted to a specific range.

### BRIEF DESCRIPTION OF THE DRAWINGS

FIG. 1 is a diagram for illustratively showing an outline of an order processing operation in an online order system according to an embodiment of the present invention.

FIG. 2 is a schematic diagram for indicating a transmission example of progress information notification data of respective Web service processing apparatus employed in the online order system according to the embodiment.

FIG. 3 is a schematic diagram for indicating a transmission example in the case that a transmission range of the progress information notification data of the embodiment is not present.

FIG. 4 is a diagram for showing detailed contents of progress information request data used in the online order system of FIG. 1.

FIG. 5 is a block diagram for showing a schematic arrangement of the Web service processing apparatus according to the embodiment.

FIG. 6 is a diagram for indicating one example of an order system order 107 of the embodiment.

FIG. 7 is a diagram for representing one example of transmission data of a basic structure appliance order of the embodiment.

FIG. 8 is a diagram for showing an example of transmission data as to order data of an optional appliance of the embodiment.

FIG. 9 is a flow chart for describing sequential process operations defined from a reception of order data up to a transmission of progress data according to the embodiment.

FIG. 10 is a flow chart for describing detailed process operations as to whether or not a progress notification is permitted in a step 2501 of FIG. 9 according to the embodiment.

FIG. 11 is a diagram for indicating one example of company-B service progress information notification data 801 of the embodiment.

FIG. 12 is a diagram for showing a definition example of a format as to progress information request data 402 of the embodiment.

FIG. 13 is a diagram for indicating a definition example of a format as to the company-B service progress information notification data 801 of the embodiment.

FIG. 14 is a diagram for indicating an example of a company-B Web service progress information request management table of the embodiment.

FIG. 15 is a diagram for showing another example of the company-B Web service progress information request management table of the embodiment.

FIG. 16 is a diagram for indicating an example of a company-A Web service progress information request management table of the embodiment.

FIG. 17 is a diagram for showing an example of a progress notification permission table of the embodiment.

FIG. 18 is a diagram for representing hardware structures of both a company-A Web service processing apparatus 101 and a company-B Web service processing apparatus 102, employed in the online order system according to the embodiment.

FIG. 19 is a diagram for showing a hardware structure of a company-C Web service processing apparatus 103 employed in the online order system according to the embodiment.

### DESCRIPTION OF THE EMBODIMENTS

A description is made of a service processing apparatus according to an embodiment of the present invention, while this service processing apparatus executes a process operation used to provide a predetermined service so as to transmit historical information, i.e; accumulated information on processing of service having been performed, and progress information, i.e; information on status of an operating program which has been used in processing of a service.

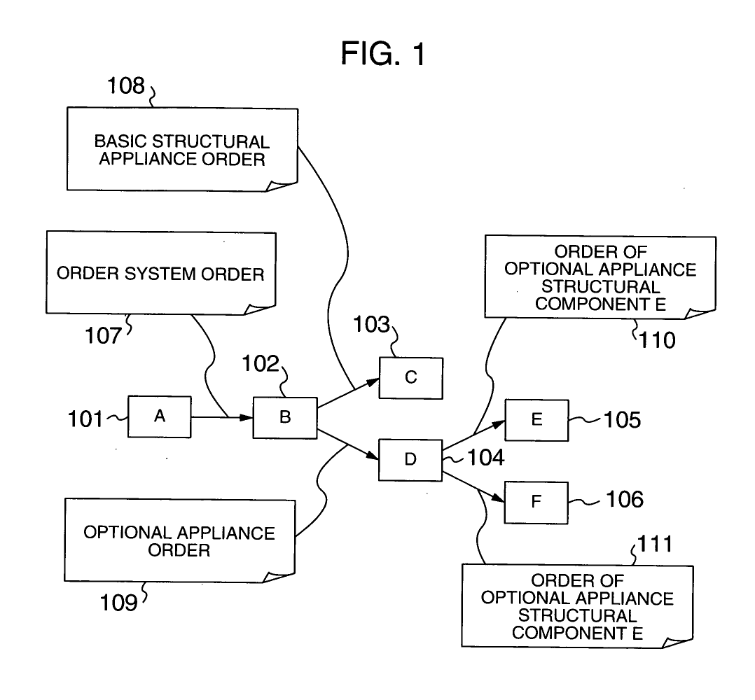

FIG. 1 is a diagram for illustratively showing an outline of an order processing operation in an online order system according to an embodiment of the present invention. In FIG. 1, such an example is exemplified in which a plurality of Web service processing apparatus are combined with each other in order to constitute the online order system.

A company-A Web service processing apparatus 101 shown in FIG. 1 is an order system-purpose apparatus of the company “A”, which makes an order of a custom order system apparatus from the company “A”. A company-B Web service processing apparatus 102 of FIG. 1 corresponds to an apparatus of the company “B”, which has received an order from the company “A”, and transmits an order of a basic structure appliance within the order-accepted order system to a company-C Web service processing apparatus 103 of FIG. 1, and also, transmits an order of an optional appliance to a company-D Web service processing apparatus 104.

In the company-D Web service processing apparatus 104, an order as to a portion of structural components of the optional appliance is further transmitted to a company-E Web service processing apparatus 105, and an order as to other structural components is transmitted to a company-F Web service processing apparatus 106 of FIG. 1.

An order system order 107 of FIG. 1 shows transmission data of the order system order 107 from the company-A Web service processing apparatus 101 to the company-B Web service processing apparatus 102. A basic structural appliance order 108 shows transmission data of the basic structural appliance order 108 from the company-B Web service processing apparatus 102 to the company-C Web service processing apparatus 103. An optional appliance order 109 represents transmission data of the optional appliance order 109 from the company-B Web service processing apparatus 102 with respect to the company-D Web service processing apparatus 104. An optional appliance structural component order 110 indicates transmission data of the optional appliance order 110 from the company-D Web service processing apparatus 104 to the company-E Web service processing apparatus 105. An optional appliance structural component order 111 indicates transmission data of the optional appliance order 111 from the company-D Web service processing apparatus 104 to the company-F Web service processing apparatus 106.

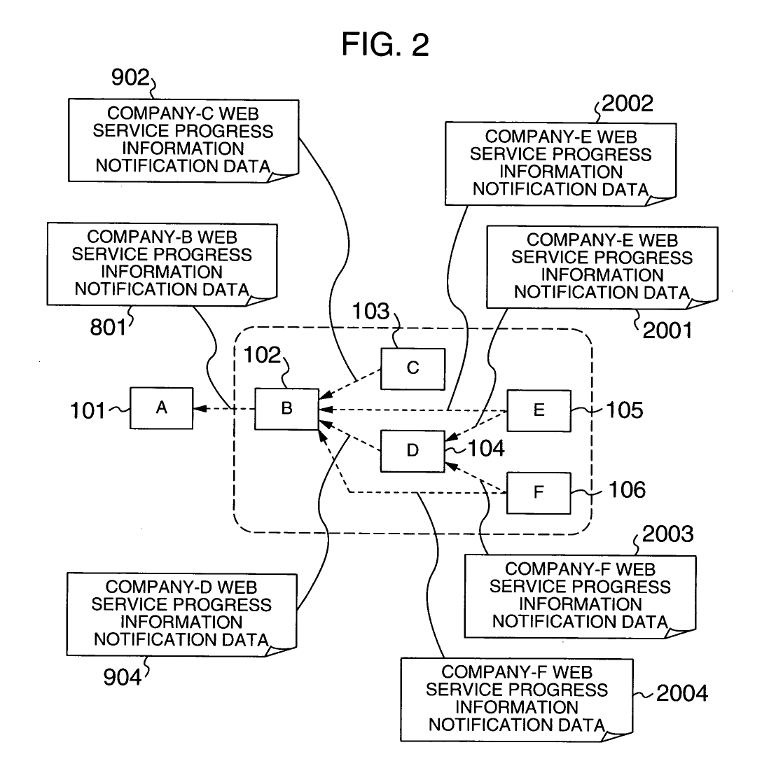

FIG. 2 is a schematic diagram for indicating a transmission example of progress information notification data of respective Web service processing apparatus according to the embodiment. A portion surrounded by a broken line in this drawing shows a range where progress information notification data is transmitted. In other words, a company-F Web service processing apparatus 106 transmits progress information notification data to both the company-B Web service processing apparatus 102 and the company-D Web service processing apparatus 104, but does not transmit the progress notification data to the company-A Web service processing apparatus 101.

Company-B Web service progress information notification data 801 of FIG. 2 indicates process information notification data transmitted from the company-B Web service processing apparatus 102 to the company-A Web service processing apparatus 101 with respect to the order system order 107 issued from the company-A Web service processing apparatus 101.

Company-C Web service progress information notification data 902 corresponds to progress information notification data of the company-C Web service processing apparatus 103. In the case that a status of a company-C Web service processing operation is changed, this company-C Web service progress information notification data 902 is transmitted to the company-B Web service processing apparatus 102 as such a data having a similar format as that of the company-B Web service progress information data 801.

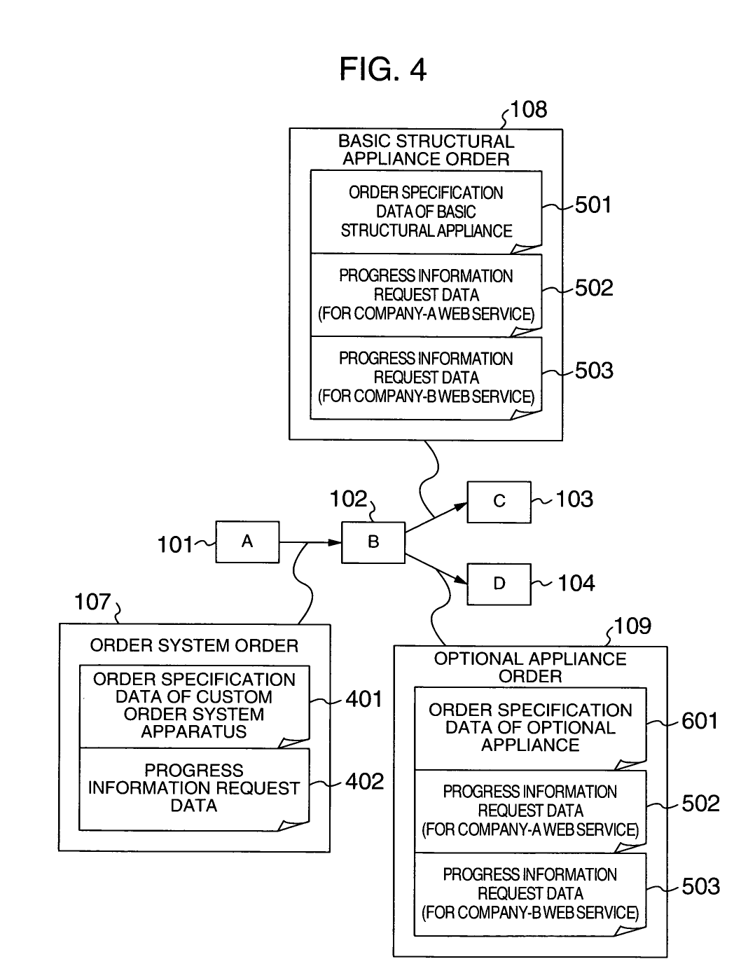

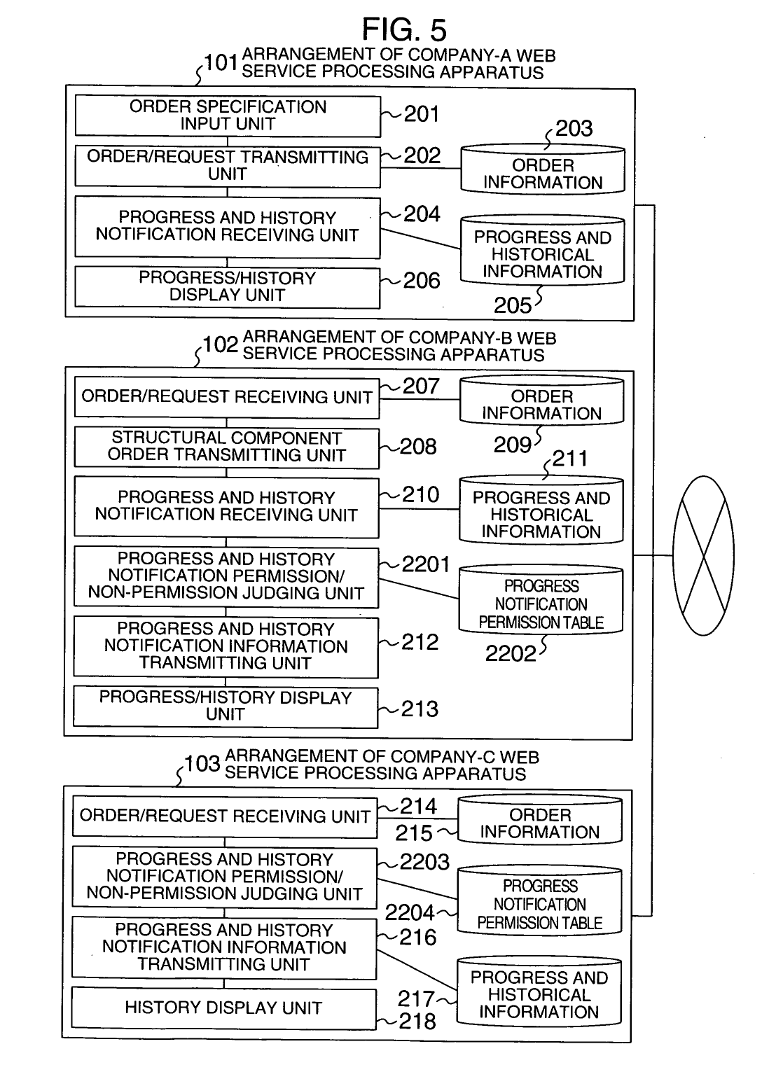

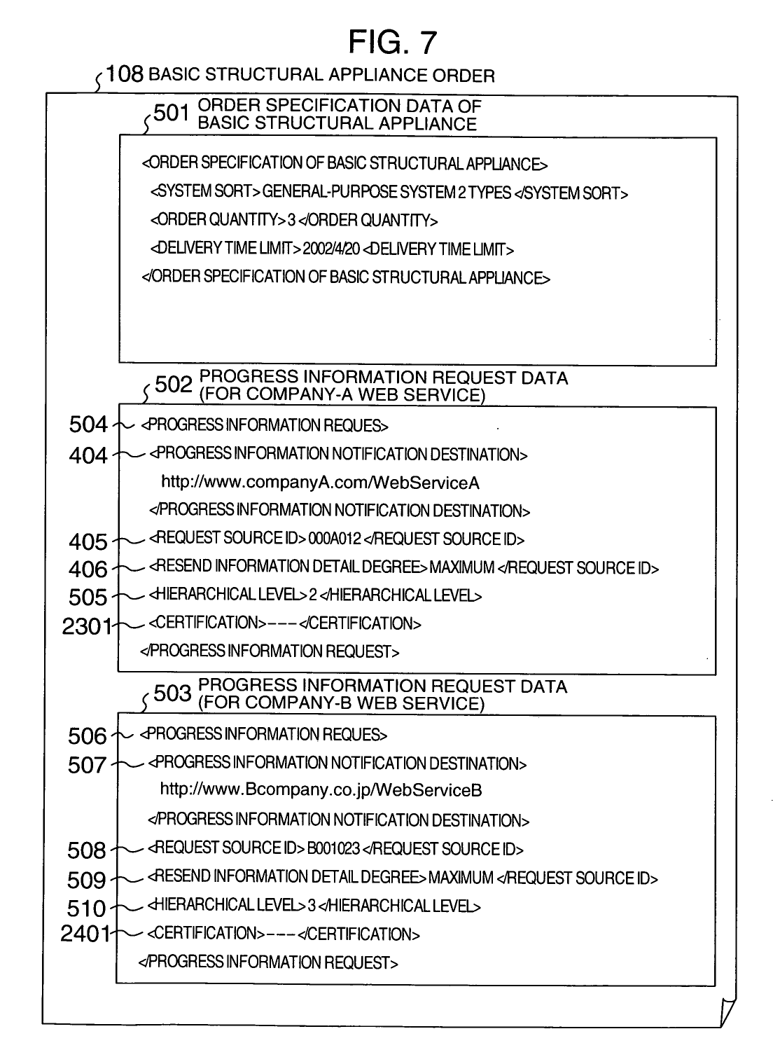

The company-C Web service progress information notification data 902 corresponds to progress data which corresponds to progress information request data (company-B Web service purpose) 503 indicated in FIG. 4. Although progress information request data (company-A Web service purpose) 502 shown in FIG. 4 is transmitted via the company-B Web service processing apparatus 102 to the company-C Web service process apparatus 103, the company-C Web service progress information notification data 902 is not transmitted to the company-C Web service processing apparatus 103 by judging both progress information notification judging information 2401, shown in FIG. 7, contained in progress information request data (company-A Web service purpose) 503 and a company-C Web service progress notification permission table 2204 shown in FIG. 5.

Similarly, company-D Web service progress information notification data 904 corresponds to progress information notification data of the company-D Web service processing apparatus 104. In the case that a status of a company-D Web service processing operation is changed, this company-D Web service progress information notification data 904 is transmitted to the company-B Web service processing apparatus 102 as such a data having a similar format as that of the company-B Web service progress information data 801. This company-D Web service progress information notification data 904 is such a progress data corresponding to progress information request data (company-B Web service purpose) 503.

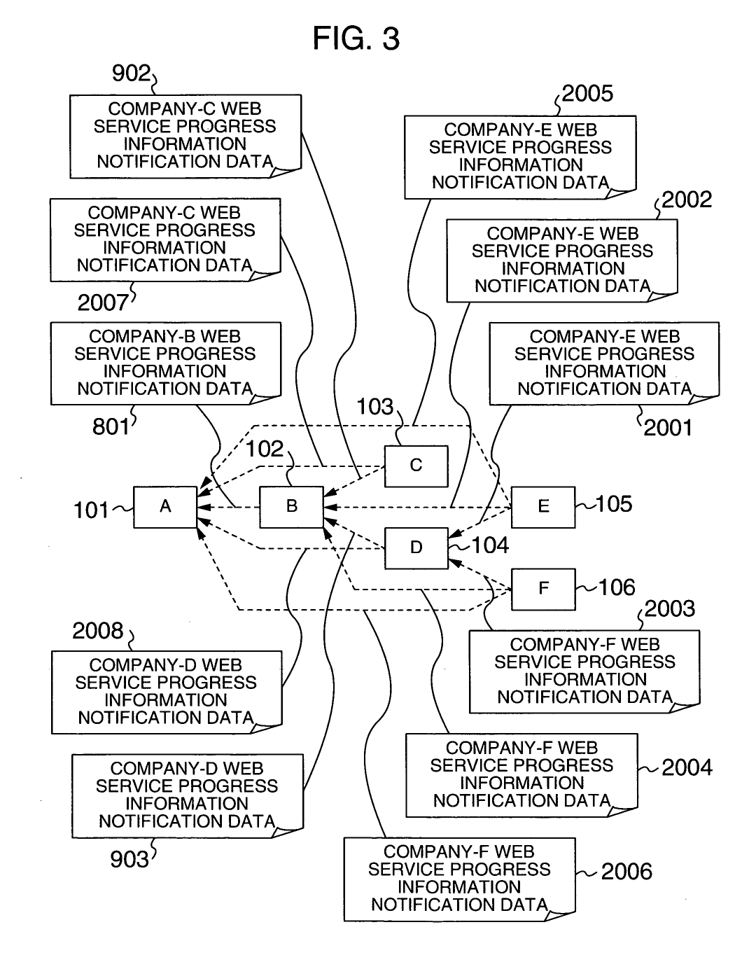

FIG. 3 is a diagram for indicating a transmission example in the case that a transmission range of progress information notification data is not present in the online order system in accordance with the embodiment. In the example of FIG. 2, the historical information and the progress information notification data are not transmitted from the company-C Web service processing apparatus 103 to the company-A Web service processing apparatus 101. However, in the example of FIG. 3, since the transmission range is not limited, company-C Web service information notification data 2007 is transmitted to the company-A Web service processing apparatus 101. Similarly, company-D Web service progress information notification data 2008, company-E Web service progress information notification data 2005, and company-F Web service progress information notification data 2006 are transmitted to the company-A Web service processing apparatus 101.

FIG. 4 is a diagram for representing a detailed content of progress information request data which is employed in the online order system of FIG. 1 according to the embodiment. In FIG. 4, a process operation is extracted from the process operations of FIG. 1, in which the company-A Web service processing apparatus 101 calls via the company-B Web service processing apparatus 102, both the company-C Web service processing apparatus 103 and the company-D Web service processing apparatus 104, and the detailed contents of the progress information request data in this extracted process operation is indicated.

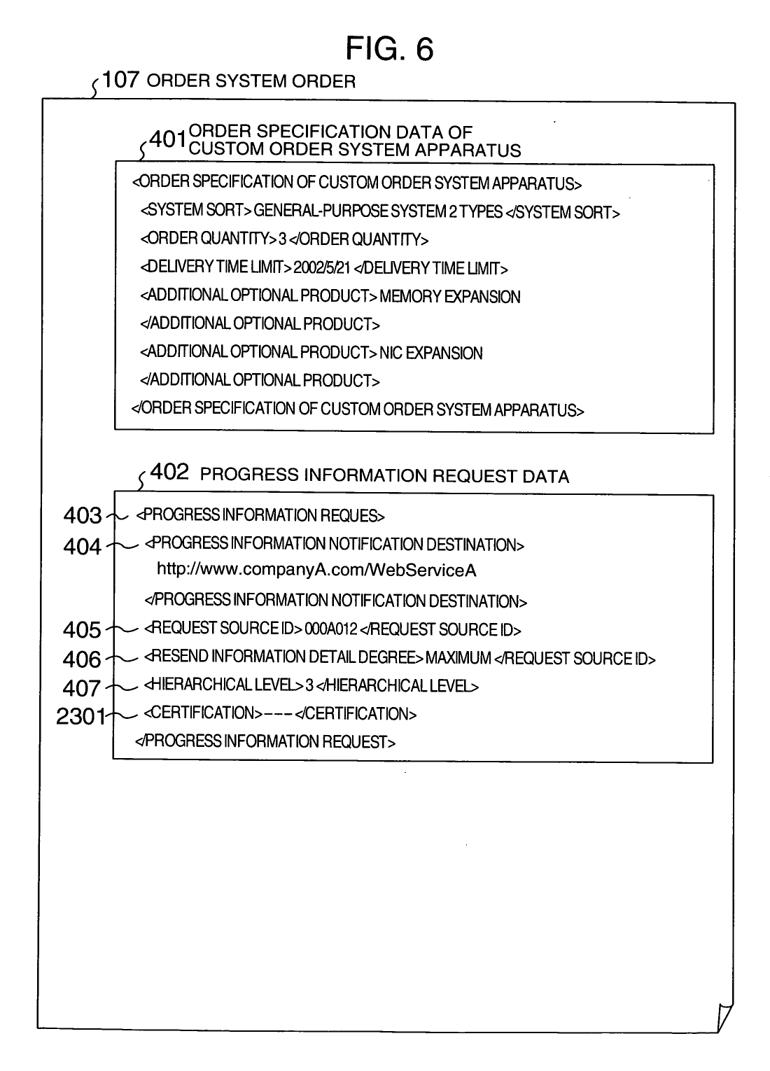

The order system order 107 shown in FIG. 4 corresponds to such an order data transmitted from the company-A Web service processing apparatus 101 to the company-B Web service processing apparatus 102. This order system 107 is constituted by order specification data 401 of a custom order system apparatus and progress information request data 402 used in a Web service progress/history managing method of the embodiment, which are indicated in FIG. 6. It is so assumed that message information as to the order specification data 401 and the progress information data 402 of the custom order system apparatus has been described in the XML (Extensible Markup Language) format as one example in this embodiment. However, the present invention is not limited only to this XML format.

Similarly, the basic structural appliance order 108 of FIG. 4 corresponds to such an order data transmitted from the company-B Web service processing apparatus 102 to the company-C Web service processing apparatus 103. This basic structural appliance order 108 is constituted by order specification data 501 of the basic structural appliance, progress information request data (for company-A Web service purpose) 502, and progress information request data (for company-B Web service purpose) 503, shown in FIG. 7.

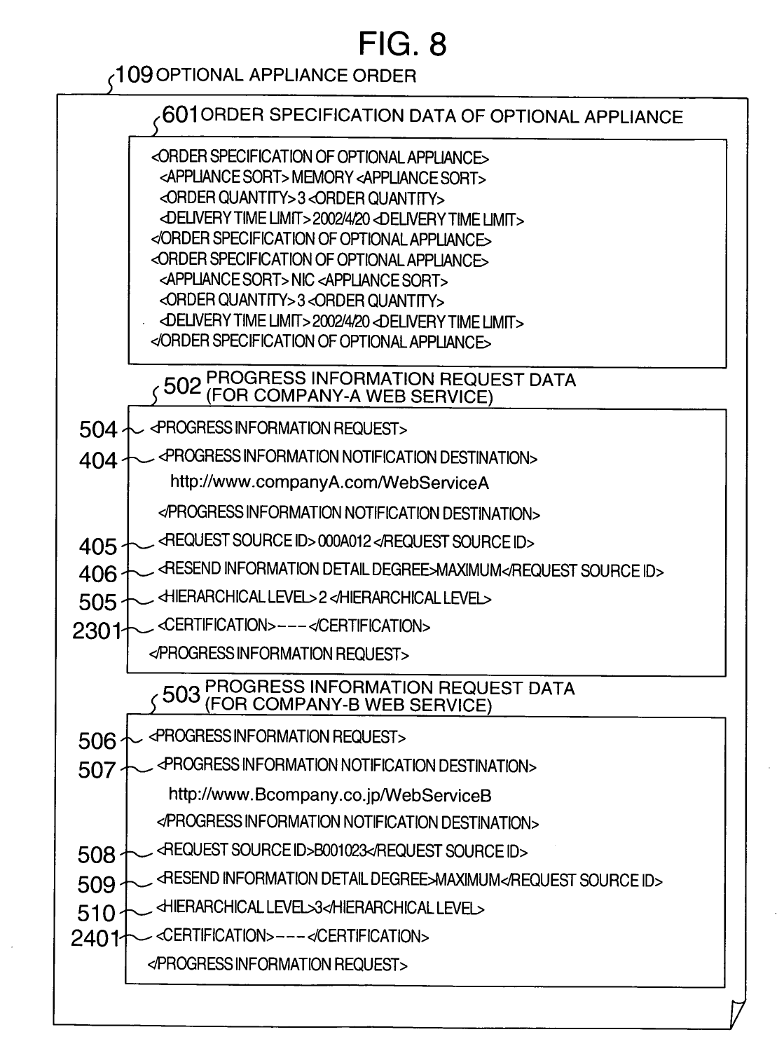

The optional appliance order 109 of FIG. 4 corresponds to such an order data transmitted from the company-B Web service processing apparatus 102 to the company-D Web service processing apparatus 104. This optional appliance order 109 is constituted by order specification data 601 of the optional appliance, the progress information request data (for company-A Web service purpose) 502, and the progress information request data (for company-B Web service purpose) 503, shown in FIG. 8.

FIG. 5 is a diagram for schematically indicating an arrangement of each of the above-described Web service processing apparatus according to the embodiment. As indicated in FIG. 5, the company-A Web service processing apparatus 101 employed in the online order system according to this embodiment contains an order specification input unit 201, an order/request transmitting unit 202, a progress and history notification receiving unit 204, and a progress/history display unit 206.

The order specification input unit 201 corresponds to a processing unit for inputting thereinto specification data used to execute an order processing operation. The order/request transmitting unit 202 corresponds to such a processing unit for transmitting order data by a communication apparatus so as to request an execution of the order processing operation. This order data contains both specification data entered by an order specification input unit 201 and progress information request data used to notify the historical information and the progress information of the above-described processing operation.

The progress and history notification receiving unit 204 corresponds to a processing unit for accepting both progress information and historical information transmitted from another Web service processing apparatus. The progress/history display unit 206 corresponds to a processing unit for displaying both the progress information and the historical information, which have been stored in a progress and historical information storage area 205.

It is also assumed that after such a program has been recorded on a recording medium such as a CD-ROM and has been stored into a magnetic disk, or the like, this program is loaded onto a memory so as to be executed. This program may cause the company-A Web service processing apparatus 101 to function as the order specification input unit 201, the order/request transmitting unit 202, the progress and history notification receiving unit 204, and the progress/history display unit 206. It should also be noted that the recording medium for recording thereon the above-described program may be alternatively substituted by other recording media than the CD-ROM. Alternatively, the above-explained program may be installed from this recording medium to an information processing apparatus so as to be used. Also, the information processing apparatus may alternatively access via a network to this recording medium so as to use the above-described program.

Further, the company-A Web service processing apparatus 101 contains an order information storage area 203, and a progress and historical information storage area 205.

The order information storage area 203 corresponds to such a storage area for storing thereinto the order data transmitted by the order/request transmitting unit 202. The progress and historical information storage area 205 corresponds to such a storage area for storing thereinto both the progress information and the historical information which are received from another Web service processing apparatus.

The company-B Web service processing apparatus 102 contains an order/request receiving unit 207, a structural component order transmitting unit 208, a progress and historical information receiving unit 210, a progress and history notification permission/non-permission judging unit 2201, a progress and history notification transmitting unit 212, and a progress/history display unit 213.

The order/request receiving unit 207 corresponds to a service providing unit operated in such a manner that the order data transmitted from the company-A Web service processing apparatus 101 is received by the communication apparatus, this received order data is stored in the memory, the specification data is read out from this stored order data, and thereafter, the order processing operation is executed by a CPU based upon this read specification'data.

The structural component order transmitting unit 208 corresponds to such a processing unit for transmitting order data by the communication apparatus so as to request an execution of a structural component order processing operation. This order data contains both specification data used to execute the structural component order processing operation by the company-C Web service processing apparatus 103 and the company-D Web service processing apparatus 104, and also progress information request data used to notify the historical information and the progress information of the above-described processing operation.

The progress and history notification receiving unit 210 corresponds to a processing unit for accepting both progress information and historical information transmitted from another Web service processing apparatus. The progress and history notification permission/non-permission judging unit 2201 corresponds to a notification permission/non-permission judging unit operated in such a manner that the progress information request data is read out from the order data stored in the storage apparatus so as to be analyzed, and then, transmission permission/non-permission information corresponding to the information contained in this analyzed progress information request data is read out from a storage apparatus to judge as to whether or not both the historical information and the progress information of the above-described process operation are notified.

The progress and historical information transmitting unit 212 corresponds to a notification information transmitting unit operated in such a manner that when the judgement is made that both the historical information and the progress information are notified, both historical information and progress information are produced on the storage apparatus based upon the progress information request data, and then, both the produced historical information and the produced progress information are transmitted to a progress information notification destination indicated in the above-explained progress information request data by the communication apparatus. The progress/history display unit 213 corresponds to a processing unit for displaying both the progress information and the historical information, which have been stored in a progress and historical information storage area 211.

It is also assumed that after such a program has been recorded on a recording medium such as a CD-ROM and has been stored into a magnetic disk, or the like, this program is loaded onto a memory so as to be executed. This program may cause the company-B Web service processing apparatus 102 to function as the order/request receiving unit 207, the structural component order transmitting unit 208, the progress and historical information receiving unit 210, the progress and history notification permission/non-permission judging unit 2201, the progress and historical information transmission unit 212, and the progress/history display unit 213. It should also be noted that the recording medium for recording thereon the above-described program may be alternatively substituted by other recording media than the CD-ROM. Alternatively, the above-explained program may be installed from this recording medium to an information processing apparatus so as to be used. Also, the information processing apparatus may alternatively access via a network to this recording medium so as to use the above-described program.

Further, the company-B Web service processing apparatus 102 contains an order information storage area 209, a progress and historical information storage area 211, and a progress notification permission table 2202.

The order information storage area 209 corresponds to such a storage area for storing thereinto the order data transmitted by the structural component order transmitting unit 208. The progress and historical information storage area 211 corresponds to such a storage area for storing thereinto both the progress information and the historical information which are received from another Web service processing apparatus. The progress notification permission table 2202 corresponds to a table which has stored thereinto data for judging as to whether or not the historical information and the progress information of the process operation are notified.

The company-C Web service processing apparatus 103 contains an order/request receiving unit 214, a progress and history notification permission/non-permission judging unit 2203, a progress and historical information transmitting unit 216, and a progress display unit 218.

The order/request receiving unit 214 corresponds to a service providing unit operated in such a manner that the order data transmitted from the company-B Web service processing apparatus 102 is received by the communication apparatus, this received order data is stored in the storage apparatus, the specification data is read out from the stored order data, and thereafter, the order process operation is executed by the CPU based upon the read specification data.

The progress and history notification permission/non-permission judging means 2203 corresponds to a notification permission/non-permission judging unit operated in such a manner that the progress information request data is read out from the order data stored in the storage apparatus so as to be analyzed, and then, transmission permission/non-permission information corresponding to the information contained in this analyzed progress information request data is read out from the storage apparatus to judge as to whether or not both the historical information and the progress information of the above-described process operation are notified.

The progress and historical information transmitting unit 216 corresponds to a notification information transmitting unit operated in such a manner that when the judgement is made that both the historical information and the progress information are notified, both historical information and progress information are produced on the storage apparatus based upon the progress information request data, and then, both the produced historical information and the produced progress information are transmitted to a progress information notification destination indicated in the above-explained progress information request data by the communication apparatus. The history display unit 218 corresponds to a processing unit for displaying thereon the historical information which has been stored in the progress and historical information storage area 217.

It is also assumed that after such a program has been recorded on a recording medium such as a CD-ROM and has been stored into a magnetic disk, or the like, this program is loaded onto a memory so as to be executed. This program may cause the company-C Web service processing apparatus 103 to function as the order/request receiving unit 214, the progress and history notification permission/non-permission judging unit 2203, the progress and historical information transmitting unit 216, and the progress display unit 218. It should also be noted that the recording medium for recording thereon the above-described program may be alternatively substituted by other recording media than the CD-ROM. Alternatively, the above-explained program may be installed from this recording medium to an information processing apparatus so as to be used. Also, the information processing apparatus may alternatively access via a network to this recording medium so as to use the above-described program.

Further, the company-C Web service processing apparatus 103 contains an order information storage area 215, a progress and historical information storage area 217, and a progress notification permission table 2204.

The order information storage area 215 corresponds to such a storage area for storing thereinto the order data received by the order/request receiving unit 214. The progress and historical information storage area 214 corresponds to such a storage area for storing thereinto both the progress information and the historical information which are received from another Web service processing apparatus. The progress notification permission table 2204 corresponds to a table which has stored such a data used to judge as to whether or not the historical information and the progress information of the above-described process operation are notified.

It should also be understood that FIG. 5 indicates the detailed arrangements as to the company-A Web service processing apparatus 101, the company-B Web service processing apparatus 102, and the company-C Web service processing apparatus 103 among the respective Web service processing apparatus shown in FIG. 1. It is assumed that other Web service processing apparatus own similar arrangements to the above-explained detailed arrangements.

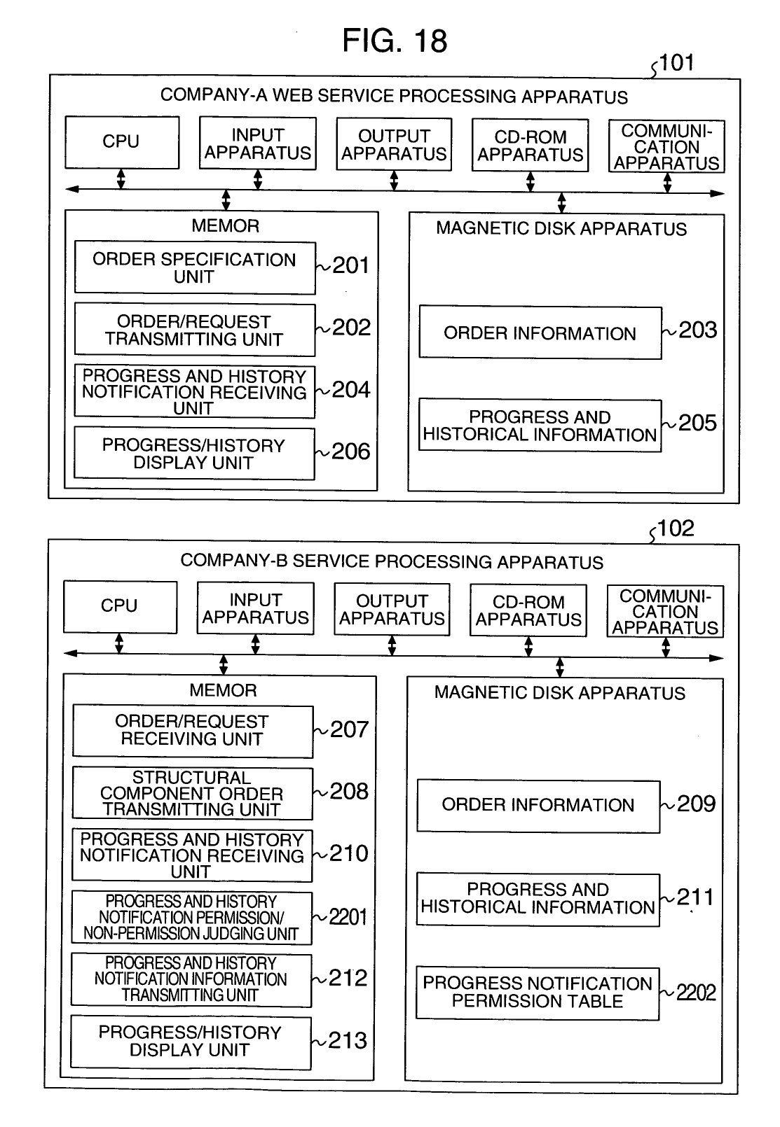

FIG. 18 is a schematic block diagram for indicating hardware constructions as to both the company-A Web service processing apparatus 101 and the company-B Web service processing apparatus 102, employed in the online order system according to the embodiment. As indicated in FIG. 18, in the company-A Web service processing apparatus 101, the order specification input unit 201, the order/request transmitting unit 202, the progress and history notification receiving unit 204, and the progress/history display unit 206 are stored in the memory, whereas the order information storage area 203, and the progress and historical information storage area 205 are provided in the magnetic disk apparatus.

Also, in the company-B Web service processing apparatus 102, the order/request receiving unit 207, the structural component order transmitting unit 208, the progress and historical information receiving unit 210, the progress and history notification notification permission/non-permission judging unit 2201, the progress and historical information transmitting unit 212, and also the progress/history display unit 213 are stored in the memory, whereas the order information storage area 209, the progress and historical information storage area 211, and the progress notification permission table 2202 are provided in the magnetic disk apparatus.

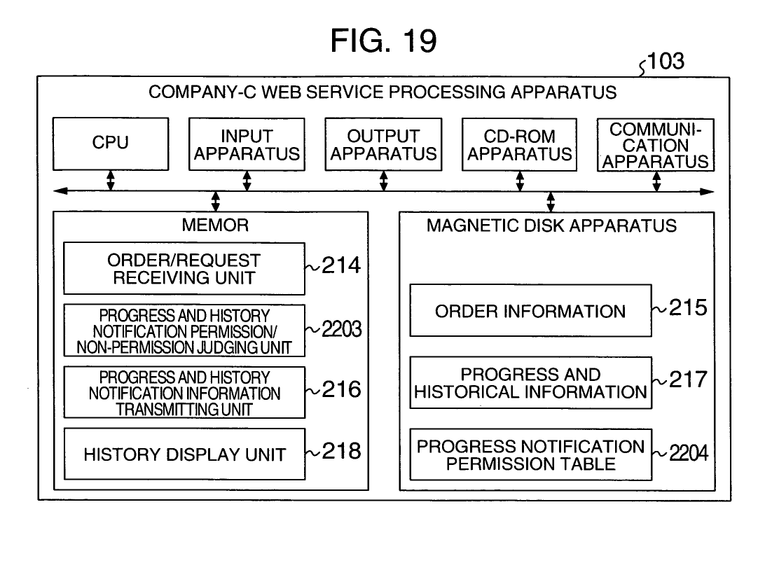

FIG. 19 is a schematic block diagram for indicating a hardware construction as to the company-C Web service processing apparatus 103 employed in the online order system, according to the embodiment. As indicated in FIG. 19, in the company-C Web service processing apparatus 103, the order/request receiving unit 214, the progress and history notification notification permission/non-permission judging unit 2203, the progress and historical information transmitting unit 216, and the history display unit 218 are stored in the memory, whereas the order information storage area 215, the progress and historical information storage area 217, and the progress notification permission table 2204 are provided in the magnetic disk apparatus.

FIG. 6 is a diagram for representing an example of the order system order 107 employed in the embodiment. Order specification data 401 of a custom order system apparatus corresponds to such an order specification data which is designated when the company-A Web service processing apparatus 101 makes an order of the custom order system apparatus to the company-B Web service processing apparatus 102, and also, corresponds to such a data which is designated when a function of each of these Web service processing apparatus is utilized.

Contents of the order specification data 401 of the custom order system apparatus correspond to data made in response to contents of the respective Web services. As the order specification data of the custom order system, there are a system sort, an ordered quantity, a delivery time limit, and an optional product. As these order specification data items, “2 types of general-purpose system”, “3”, “2002/5/21”, “memory expansion”, and “NIC expansion” are designated. The data are such data required in order that each of the Web service processing apparatus executes a process operation for providing a service, while formats of these data are determined which are designated based upon contents of the respective services. The order specification data 401 of the custom order system of FIG. 6 corresponds to one example thereof.

The progress information request data 402 corresponds to such an information which is used to manage progress/historical information of a plurality of systems, while request information used to request both progress information and historical information is transferred among a plurality of the Web service processing apparatus in multiple stages.

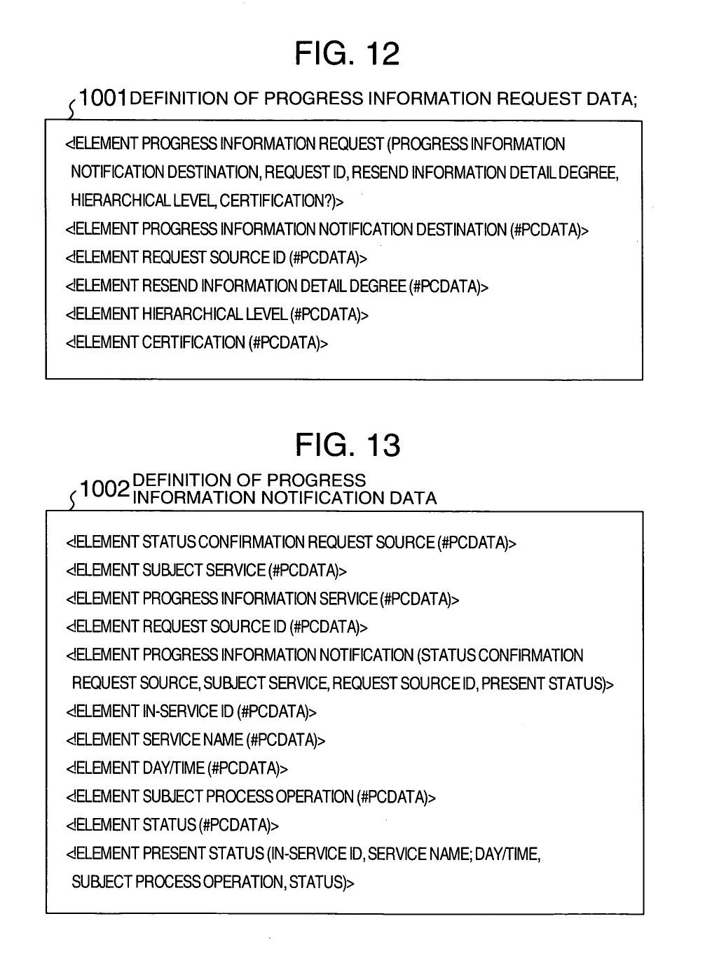

FIG. 12 is a diagram for indicating a definition example of a format as to the progress information request data 402 employed in this embodiment. A format definition example 101 of the progress information request data 402 shown in FIG. 12 represents the definition example of the format as to the progress information request data 402.

To make a definition, DTD (Document Type Definition) is employed which corresponds to one sort of schema language of XML. Each of elements is defined by employing symbol “<!ELEMENT”. For example, <!ELEMENT progress information request (progress information notification destination, request source ID, resend information detail degree, hierarchical level, certification ?> indicates that an element called as a progress information request is constituted by such a certification that the progress information notification destination, the request source ID, the resend information detail degree, and the hierarchical level are 1 piece, 0 piece, or 1 piece, respectively.

Information 403 to 407 and information 2301 of FIG. 6 correspond to the items as to the progress information request data, the progress information notification destination, the request source ID, the resend information detail degree, the hierarchical level, and the certification, which are defined in the progress information request data format definition example 101. The detailed contents of the respective items will now be indicated as examples.

The progress information request data 402 shows a detailed content of the progress information request data. The information 403 designates “progress information request” in order that this information is an information group for notifying the progress information to the company-A Web service processing apparatus 101. The information 403 defines the progress information request, and contains the information 404 to 407 for notifying the progress information within the progress information request.

The information 404 corresponds to information as to the progress information notification destination, to which information indicative of the notification destination of the progress information is set. In this embodiment, such an information that the progress information is accepted by the company-A Web service processing apparatus 101 is set by URL (Uniform Resource Locator).

The progress information request data 402 of FIG. 6 corresponds to such a data which has been set by the company-A Web service processing apparatus 101 as the progress information request. Alternatively, this progress information request data 402 may be set as follows. That is, while another Web service processing apparatus for managing both the progress information and the historical information is installed irrespective of the company-A Web service processing apparatus 101, instead of the information used to accept the progress information by the company-A Web service processing apparatus 101, such a URL of a progress information accepting destination of the Web service processing apparatus for managing both the progress information and the historical information, which is installed irrespective of the company-A Web service processing apparatus 101 may be designated as the progress information notification destination of the information 404.

The information 405 corresponds to the request source ID, and is used to designate data which is employed so as to manage order data by the company-A Web service processing apparatus 102. When the progress information notification data is transmitted from the company-B Web service processing apparatus 102 to the company-A Web service processing apparatus 101, since this request source ID is designated within the progress information notification data, the company-A Web service processing apparatus 101 can identify that the notification information is notified in response to which order. In this embodiment, “000A012” is designated as the request source ID. Alternatively, other data formats such as character strings and numeral values may be employed if such a data is available which can discriminate the order data equal to a request issued from the company-A Web service processing apparatus 101 from the progress information notification data transmitted from each of these Web service processing apparatus in response to this order data.

The information 406 corresponds to such a data indicative of the resend information detail degree, and also corresponds to such an information for indicating that a progress information management to be notified to the company-A Web service processing apparatus 101 is transmitted in which unit. In this embodiment, this information 406 designates a maximum, and indicates that such a progress information is resent in the maximum unit which can be solved as the progress information of the business logic within the company-B Web service processing apparatus which has received this progress information request data. When the resend information detail degree is “maximum”, the information 406 implies that possibly large progress information is requested, for instance, in the case that a business process of each service is arranged by a plurality of business steps, progress information as to the respective business steps is required.

For example, in such a case that the respective business step of the business process are constituted by “acceptance process operation”, “examination”, “confirmation of delivery time limit”, “delivery order”, and the like, progress information with respect to the respective business steps is notified. It is so assumed that as the resend information detail degree, such progress notification data for designating “debug”, “maximum”, “input and output”, “minimum”, “error”, and the like may be employed in the unit of the progress information to be notified, which also includes the above-explained example. In this example, it is so assumed that there are the largest pieces of progress notification information data which are notified by “debug”, and there are the minimum pieces of the progress notification information data which are notified by “error”.

The item of the resend information detail degree corresponds to such a value which indicates a unit expected by the company-A Web service processing apparatus 101 which requires the progress information notification data. Each of the services for returning the progress information notification data resends the progress information notification data in the unit returned in each of the services based upon the above-described information. The item of “debug” is assumed as follows: That is, at a stage for processing each of the business steps which are notified when “maximum” is designated, this item of “debug” is used to designate that more detailed progress information including also data required for a debugging operation is notified, and is used in a test, or the like. The item of “input and output” indicates that progress notification information is required as to inputs and outputs of the respective services with respect to an external unit, for example, in the case that a request for each of the services is received, and in the case that a further request for each of the services is issued. Also, the item of “minimum” shows that progress notification information having a minimum level is requested which is required by each of the services when the normal operation is carried out. The item of “error” represents that progress notification information is requested only when such a problem happens to occur which does not occur during the normal operation.

The resend information detail degree indicates the subject unit of the progress information. Alternatively, this resend information detail degree may designate a sort of required progress information and a filtering condition in such a form for acquiring progress information related to a specific sort, for example, “start” and “completion” with respect to a process step for requesting another Web system.

Hierarchical layers of the information 407 in FIG. 6 are used to designate a notification range of progress information in the case that a services of process operations are constituted by a plurality of Web service processing apparatus. In the hierarchical levels, stage numbers counted from a first Web service processing apparatus are designated by using numeral values in such a manner that a first supply-destination Web service processing apparatus is set as a first hierarchical stage, which is counted from such a Web service processing apparatus for requiring a service; and when the first supply-destination Web service processing apparatus furthermore calls another Web service processing apparatus, this Web service processing apparatus is set as a second hierarchical stage. In other words, in such a case that progress conditions defined from the company-A Web service processing apparatus 101 up to two levels are wanted to be grasped, for example, progress information request data 402 in which “2” has been designated in the hierarchical level is transmitted to the company-B Web service processing apparatus 102. Then, the company-B Web service processing apparatus 102 transmits the progress information request data 402 in which “1” has been designated in the hierarchical level to the company-C Web service processing apparatus 103. Since the hierarchical level is equal to 1 in the company-C Web service processing apparatus 103, this company-C Web service processing apparatus 103 judges that the progress information request is not transmitted to such Web service processing apparatus lower than the own Web service processing apparatus.

In the example of the information 407 shown in FIG. 6, “3” has been designated in the hierarchical level. This hierarchical level shows that the ranges for notifying the progress information to the company-A Web service processing apparatus 101 are three stages.

The certification of the information 2301 is used in the case that a judgement is made as to whether or not a Web service processing apparatus which has received a progress information request is permitted to transmit progress information notification data to a Web service processing apparatus of a request source. In the example of the information 2301 of FIG. 6, it is so assumed that an electronic certification of the company-A Web service processing apparatus 101 has been designated.

While the progress information request data 402 shown in FIG. 6 is set, since the request is issued from the company-A Web service processing apparatus 101 to the company-B Web service processing apparatus 102 in combination with the order specification data 401 of the custom order system apparatus, even in such a case that interfaces related to the progress information are separately formed among the respective Web service processing apparatus and such process operations specific to the respective Web service processing apparatus are not formed, the progress information can be notified by way of the data format which is commonly used in a plurality of these Web service processing apparatus.

FIG. 7 is a diagram for indicating one example as to transmission data of a basic structural appliance order used in the online order system of the embodiment. FIG. 7 represents contents of data which is transmitted as the basic structural appliance order 108 from the company-B Web service processing apparatus 102 to the company-C Web service processing apparatus 103. This transmission data is arranged by order specification data 501 of the basic structural appliance, progress information request data (for company-A Web service) 502, and another progress information request data (for company-B Web service) 503. The order specification data 501 indicates the content of the order as to the basic structural appliance. The progress information request data 502 is used to request a notification of the progress information to the company-A Web service processing apparatus 101. The progress information request data 503 is used to request a notification of the progress information to the company-B Web service processing apparatus 102.

As represented in the order specification data 501 of the basic structural appliance shown in FIG. 7, in this embodiment, as the data related to the order of the basic structural appliance, “general-purpose system 2 types”, “3”, and “2002/4/20” are designated with respect to the system sort, the order quantity, and the delivery time limit, respectively. Both the system sort and the order quantity correspond to the values of the same items of the order specification data 401 of the custom order system shown in FIG. 6. As to the delivery time limit, based upon the value of the order specification data 401 of the custom order system apparatus shown in FIG. 6, such a value is designated. That is, this value is calculated by subtracting a time duration required for assembling both the basic structural appliance and the optional appliance from a time instant when both the basic structural appliance and the optional appliance are delivered.

The progress information request data (for company-A Web service) 502 of FIG. 7 corresponds to such an information used to resend the progress information to the company-A Web service processing apparatus 101, and is produced based upon the progress information request data 402 sent from the company-A Web service processing apparatus 101. The various sorts of information from the progress information notification destination of the information 404 up to the resend information detail degree of the information 404 shown in FIG. 7 are similar to the progress information request data 402 transmitted from the company-A Web service processing apparatus 101, shown in FIG. 6. As to a hierarchical level of the information 505, since the information 505 is transmitted via the company-B Web service processing apparatus 102, the hierarchical level becomes such a value reduced by 1 stage, and thus, “2” is designated.

The progress information request data (for company-B Web service) 503 of FIG. 7 corresponds to such an information data used to request the progress information to the company-B Web service processing apparatus 102, and owns a similar format to the formats of the progress information request data 402, and the progress information request data 502 (used for company-A Web service). The information 507 of FIG. 7 corresponds to a notification destination of the progress information, and designates a URL indicative of a reception destination as to the progress and history notification information of the company-B Web service processing apparatus 102. The information 508 of FIG. 7 corresponds to an ID used to identify a specific order, which has been set by the company-B Web service processing apparatus 102. In this embodiment, “maximum” is designated for the resend information detail degree of the information 509, and “3” is designated for the hierarchical level of the information 510. The certification of the information 2401 designates the certification of the company-B Web service processing apparatus 102.

FIG. 8 is a diagram for indicating one example as to transmission data of an optional appliance order used in the online order system of the embodiment. FIG. 8 represents contents of data which is transmitted as the optional appliance order 109 from the company-B Web service processing apparatus 102 to the company-D Web service processing apparatus 104. This transmission data is arranged by order specification data 601 of the optional appliance, progress information request data (for company-A Web service) 502, and another progress information request data (for company-B Web service) 503. The order specification data 601 indicates the content of the order as to the optional appliance. The progress information request data 502 is used to request a notification of the progress information to the company-A Web service processing apparatus 101. The progress information request data 503 is used to request a notification of the progress information to the company-B Web service processing apparatus 102.

The order specification data 601 of the optional appliance indicates a request content used to order an optional product required for the company-C Web service processing apparatus 103 within the order data of the order specification data 401 of the custom order system shown in FIG. 6. A sort of an appliance of the order specification data 601 of the optional appliance is determined based upon an additional optional product of the order specification data 401 of the custom order system apparatus. In this example, two products of “memory” and “NIC” are designated. Also, as an order quantity, “3” is designated which is equal to that of the order specification data 401 of the custom order system apparatus. With respect to the delivery time limit, based upon the value of the order specification data 401 of the custom order system apparatus shown in FIG. 6, such a value is designated. That is, this value is calculated by subtracting a time duration required for assembling both the basic structural appliance and the optional appliance from a time instant when both the basic structural appliance and the optional appliance are delivered.

In this embodiment, both the progress information request data (for company-A Web service) 502 and the progress information request data (for company-B Web service) 503 shown in FIG. 8 own similar contents of both the progress information request data (for company-A Web service) 502 and the progress information request data (for company-B Web service) 503, which are included in the basic structural appliance order 108 which is transmitted from the company-B Web service processing apparatus 102 to the company-C Web service processing apparatus 103.

In the order specification data 601 of the optional appliance, as the order specification data of the optional appliance, two sorts as to the appliance sort, the order quantity, and the delivery time limit are designated.

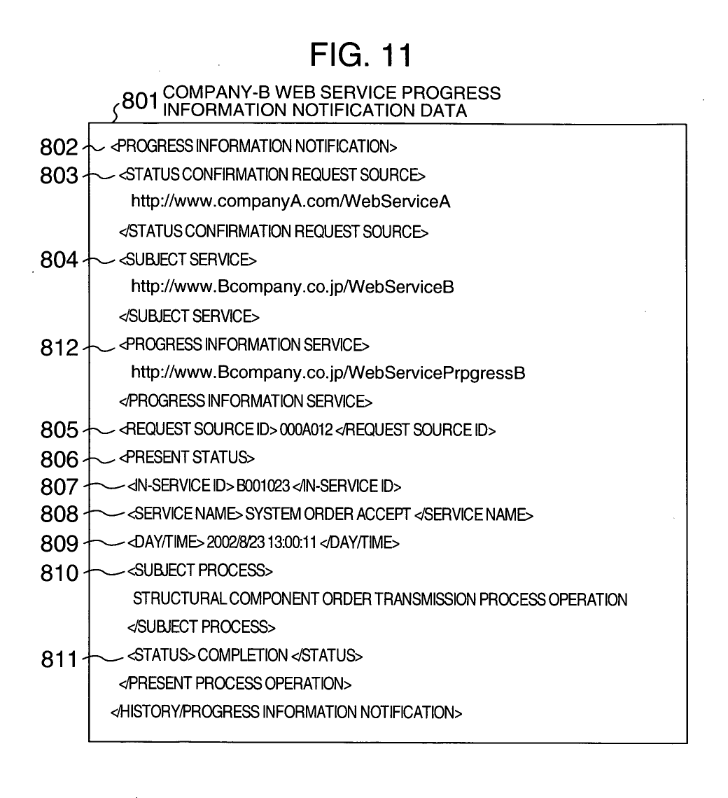

FIG. 11 is a diagram for indicating one example of the company-B Web service progress information notification data 801 employed in the online order system of the embodiment. FIG. 12 shows a content of the company-B Web service progress information notification data 801 which is transmitted to the company-A Web service processing apparatus 101 in such a case that the condition of the company-B Web service processing operation is changed.

FIG. 13 is a diagram for indicating a definition example of a format of the company-B Web service progress information notification data 801, according to this embodiment. A progress information notification data format definition example 1002 of FIG. 13 is a definition for the format of the company-B Web service progress information data 801.

Information 802 through information 811 of FIG. 11 correspond to respective items of a service ID, a service name, day/time, a subject process operation, and a status, which are equal to detailed items of present conditions and progress information notifications which contain a condition confirmation request source, a subject service, a request source ID, and present conditions, which are defined by the progress information notification data format definition example 1002. Detailed contents of the respective items are exemplified by way of examples.

The information 802 of FIG. 11 shows that this information 802 is equal to progress information notification data, and contains such information defined from a condition confirmation request source of the information 803 up to the present condition of the information 806.

The condition confirmation request source of the information 803 shows information as a source for requesting progress information, and owns the same content as to progress information notification destination of the information 404 of the progress information request data 402.

The information 804 indicates a subject of progress information which is indicated by the company-B Web service information notification data 801. In this case, a URL indicative of the company-B Web service processing apparatus 102 is designated.

The information 805 represents a request source ID, and designates the same content as the request source ID of the information 405 of the progress information request data 402. Based upon this information 805, such a judgement can be made that the request source of the progress information is equal to the progress information corresponding to which order.

The present condition of the information 806 corresponds to a condition which shows a condition after the status in the company-B Web service processing apparatus 102 has been changed, and contains such information defined from the in-service ID of the information 807 up to the status of the information 811.

The in-service ID of the information 807 corresponds to such an ID for identifying a subject within the company-B Web service processing apparatus 102. This in-service ID may be used so as to designate the subject in such a case that the company-A Web service processing apparatus 101 requests the latest progress status of the company-B Web service processing apparatus 102, and in the case that historical information is requested at arbitrary time except for such a timing when the company-B Web service progress information notification data 801 is received.

The service name of the information 808 corresponds to a service name of a company-B Web service. In the case that progress information transmitted from a plurality of Web service processing apparatus is mixed with each other to be displayed, since this service name is used, this service name can represent the progress information sent from which Web service processing apparatus.

The day/time of the information 810 shows such a day/time when a status is changed.

The subject process of the information 810 indicates a business step name whose status is changed when a business process within the company-B Web service processing apparatus 102 is constituted by a plurality of business steps.

The status of the information 811 indicates that the subject process of the information 810 has been changed into which status. Values indicative of various statuses are entered to the status of the information 811, while these statuses represent “completion”, “under execution”, “under stop”, “wait for reception”, “unexecution”, “forcibly stop”, “externally requested stop”, “abnormal completion”, “execution omit”, and so on.

The progress information service of the information 812 indicates such a Web service processing apparatus as an inquiry destination in the case that the latest progress information is wanted to be confirmed with respect to the company-B Web service processing apparatus 102.

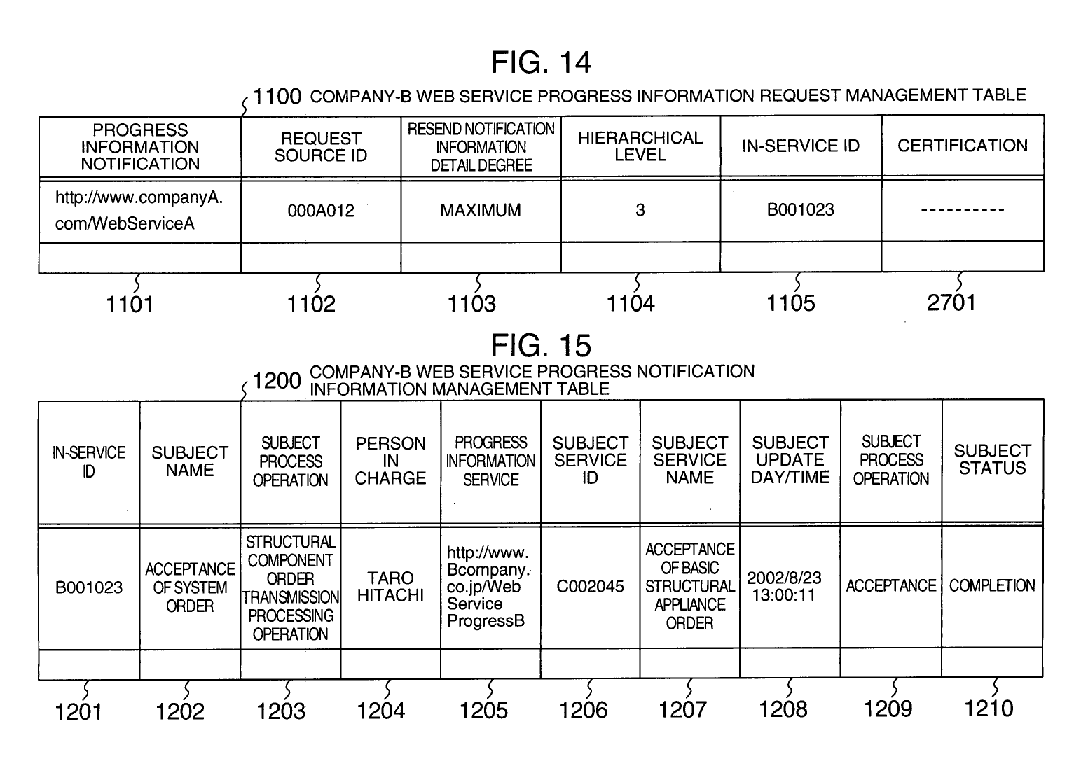

FIG. 14 is a diagram for indicating an example of a company-B Web service progress information request management table 1100. In this table 1100, a progress information destination 1101, a request source ID 1102, a resend information detail degree 1103, a hierarchical level 1104, and a certification 2701 are items corresponding to the above-described information 404 to 407 and 2301 of the progress information request data 402 transmitted from the company-A Web service processing apparatus 101. The in-service ID 1105 corresponds to such a data which has been employed within the service in a unique manner. In the case that a status of a subject is changed, this in-service ID 1105 is used so as to specify a notification destination of progress information. The certification 2701 is used to judge as to whether or not the progress information notification data is transmitted to the progress information request source.

FIG. 15 is a diagram for showing an example of a company-B Web service progress notification information management table 1200 according to the embodiment. An in-service ID 1201 has the same value of the in-service ID 1105, and corresponds to such a data which has been employed in the service in a unique manner. A subject name 1202, a subject process 1203, and a person in charge 1204 correspond to information used to manage items within the company-B services. A progress information service 1205, a subject service ID 1206, a subject service name 1207, a subject update day/time 1208, a subject process 1209, and a subject condition 1210 correspond to such areas for storing thereinto progress information notified from other Web service processing apparatus.

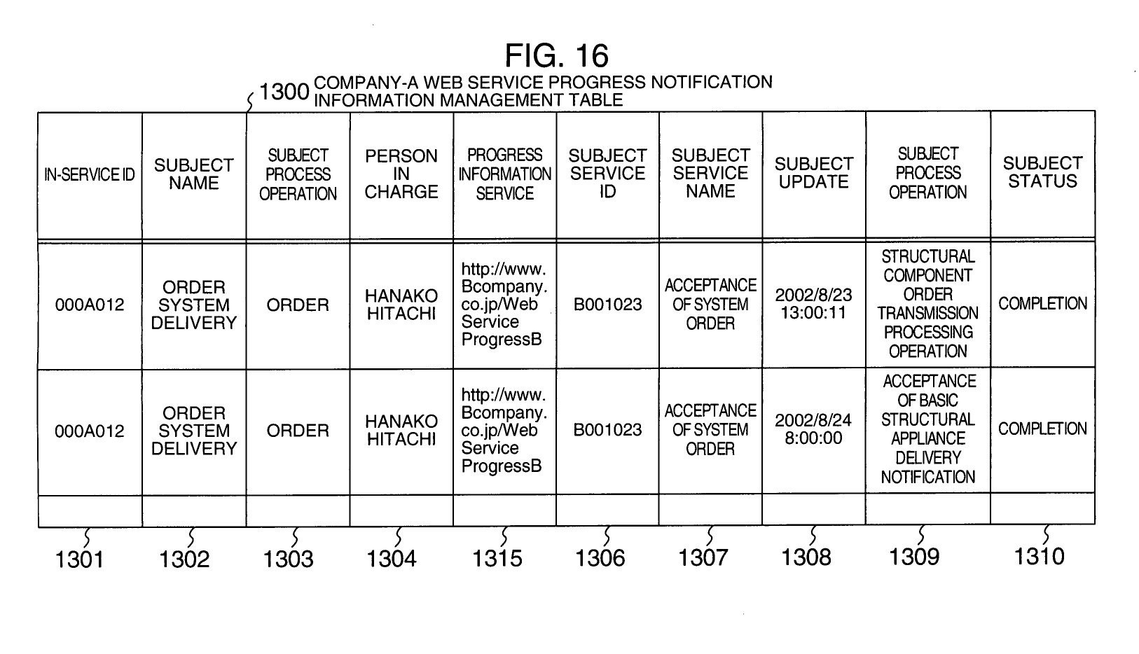

FIG. 16 is a diagram for showing an example of a company-A Web service progress notification information management table 1300 according to the embodiment. Contents defined from an in-service ID 1301 to a subject status 1310 are similar to the contents defined from the in-service ID 1201 to the subject status 1210 of the progress notification information of the company-B Web service processing apparatus 102.

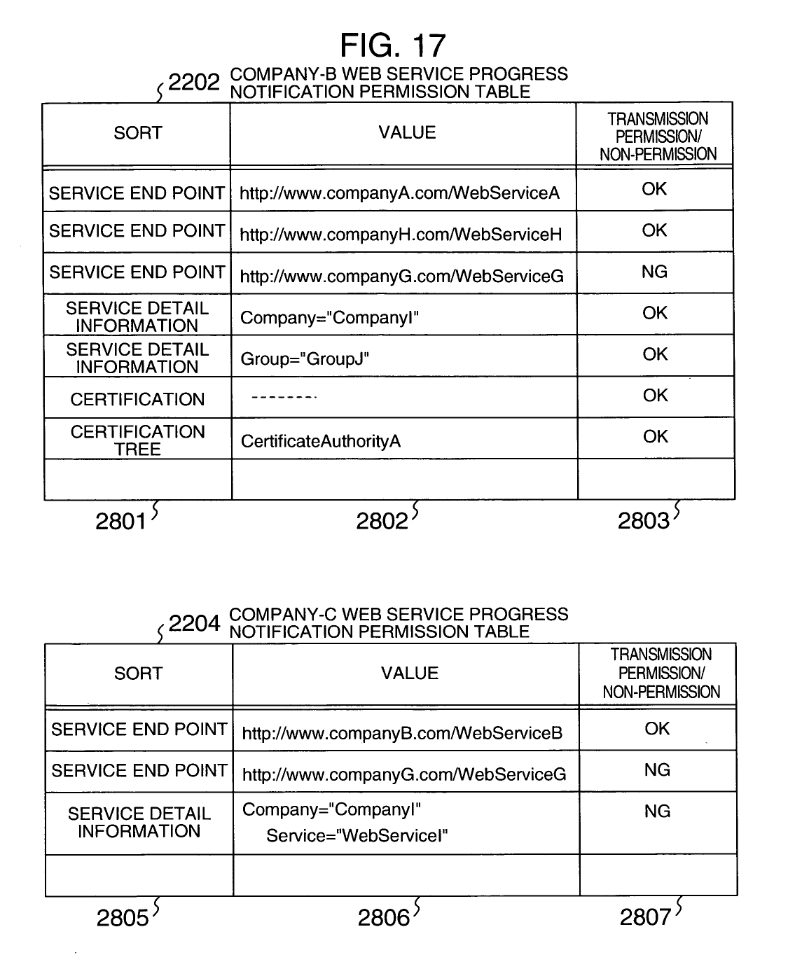

FIG. 17 is a diagram for indicating an example of a progress notification permission table according to the embodiment. FIG. 17 represents both progress notification permission tables 2202 and 2204, which manage such information for judging as to whether or not the progress information notifications of the company-B Web service processing apparatus 102 and the company-C Web service processing apparatus 103 are permitted. Sorts 2801 and 1805 have stored thereinto sorts of items when a retrieving operation is carried out from the table. Values 2802 and 2806 have stored thereinto contents corresponding to the sort 2801. Transmission permissions/non-permissions 2803 and 2807 have stored thereinto transmission permission/non-permission information for indicating as to whether or not the transmission can be carried out.

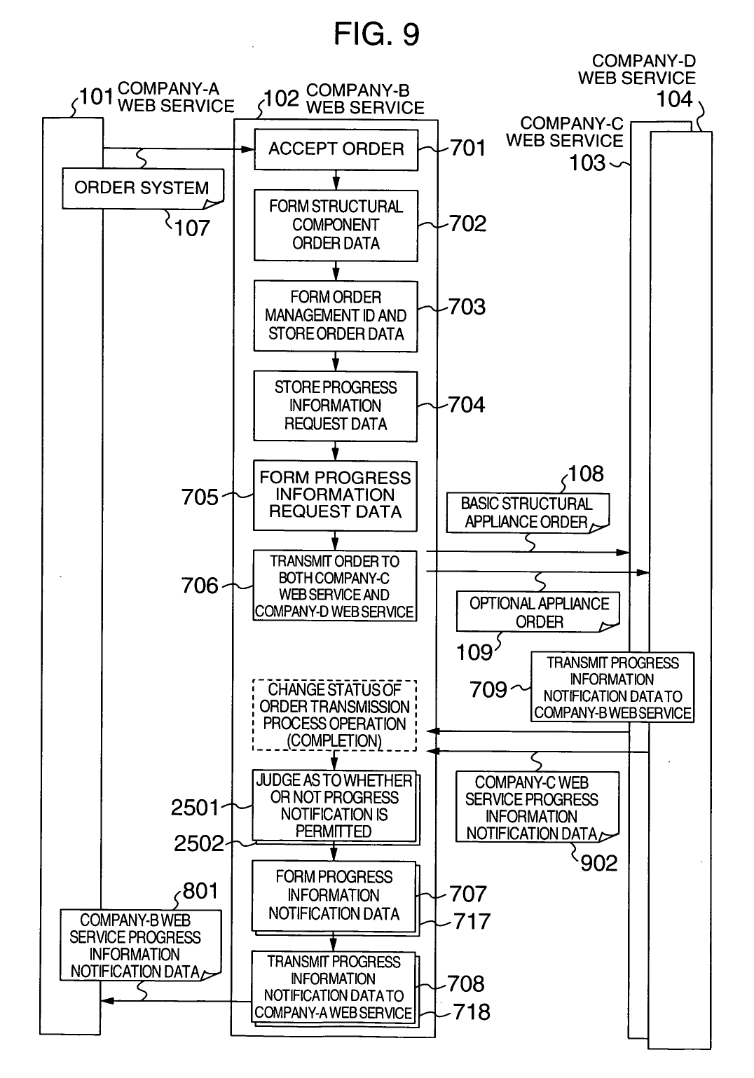

FIG. 9 is a flow chart for describing sequential process operations of the online order system according to this embodiment, which are defined from a reception of order data until a transmission of progress data. FIG. 9 represents the sequential process operations defined from such a timing when the company-B Web service processing apparatus 102 receives data of the order system order 107 from the company-A Web service processing apparatus 101 up to such a timing that the company-B Web service processing apparatus 102 resends the progress data to the company-A Web service processing apparatus 101.

When the order specification input unit 201 of the company-A Web service processing apparatus 101 performs a process operation for inputting specification data used to execute an order process of the custom order system apparatus, and also, the order/request transmitting unit 202 transmits the order system order 107 by operating the communication apparatus so as to request an execution of the order process operation, the order/request receiving unit 207 of the company-B Web service processing apparatus 102 receives the order system order 107 transmitted from the company-A Web service processing apparatus 101 by operating the communication apparatus to accept this order 107 in a step 701. The order system order 107 contains both the order specification data 401 of the custom order system apparatus and the progress information request data 402 used to notify the historical information and the progress information of the above-described process operation.

In a step 702, in the company-B Web service processing apparatus 102, this received order system order 107 is stored in the storage apparatus, the order specification data 401 of the custom order system apparatus is read, and the content of the order data is confirmed/processed. Thereafter, both the order specification data 501 of the basic structural appliance which is transmitted to the company-C Web service processing apparatus 103 as the structural component order data, and the order specification data 601 of the optional appliance which is transmitted to the company-D Web service processing apparatus 104 are formed.

In the next step 703, a unique ID is formed as an ID corresponding to the order system order 107, and the order data of this order system order 107 is stored in the order information storage area of FIG. 5. Also, in a step 704, the content of the progress information request data 402 is stored in the company-B Web service progress information request management table 1100 contained in the progress and historical information storage area 211 of FIG. 5.

In a step 705, since the hierarchical level is 3 stages in the progress information request data 402 to the company-A Web service processing apparatus 101, such a progress information request data (for company-A Web service) 502 is formed. This progress information request data 502 indicates a progress information request from both the company-C Web service processing apparatus 103 and the company-D Web service processing apparatus 104 to the company-A Web service processing apparatus 101, which constitute the structural component order destination issued from the company-B Web service processing apparatus 102. At this time, “2” is designated to the hierarchical level of the information 505, which is obtained by reducing 1 from 3 stages. At the same time, progress information request data (for company-B Web service) 505 for the company-B Web service processing apparatus 102 is formed.

Also, in order to manage corresponding relationships with respect to the progress information notification data transmitted from both the company-C Web service processing apparatus 103 and the company-D Web service processing apparatus 104, various sorts of information such as the in-service ID 1201, the subject name 1202 managed in the company-B system, the subject process 1203, and the person in charge 1204 are stored in the company-B Web service notification information table 1200. The in-service ID 1201 corresponds to the ID formed in the step 703.

In a step 706, the structural component order transmitting unit 208 of the company-B Web service processing apparatus 102 combines the order data formed in the step 702 with the progress information request data formed in the step 705, and then, transmits the combined data to both the company-C Web service processing apparatus 103 and the company-D Web service processing apparatus 104 by way of the communication apparatus as the data for the basic structural appliance order 108 to the company-C Web service processing apparatus 103 and the data for the optional appliance order 109 to the company-D Web service processing apparatus 104, so that an execution of a basic structural appliance order processing operation, and an execution of an optional appliance order processing operation are requested.

At the time when the process operation of the step 706 is completed, the company-B Web service processing apparatus 102 changes the status of the structural component order transmission processing operation into “completion.” Since the status is changed, in a step 2501, the progress and history notification permission/non-permission judging unit 2201 of the company-B Web service processing apparatus 102 acquires a progress information notification destination 1101 while using as a key, the in-service ID 1105 of the company-B Web service progress information request management table 1110. Then, this progress and history notification permission/non-permission judging unit 2201 reads transmission permission/non-permission information from the company-B Web service progress notification permission table 2202 so as to execute such a process operation for judging as to whether or not the progress notification information is transmitted to the company-A Web service processing apparatus 101.

In the case that the judgement result is made of “transmission permission”, in a step 707, the progress and historical information transmitting unit 212 of the company-B Web service processing apparatus 102 forms the company-B Web service progress information notification data 801 of FIG. 11 indicative of a progress status within the company-B Web service processing apparatus 102 on the memory based upon the progress information request data 402 sent from the company-A Web service processing apparatus 101. In a step 708, this produced company-B Web service progress information notification data 801 is transmitted by the communication apparatus to the company-A Web service processing apparatus 101.

Also, in such a case that the status in the company-C Web service processing apparatus is changed, for example, when the basic structural appliance equal to the order product is delivered, the company-C Web service progress information notification data 902 is formed based upon the progress information request data (for company-A Web service) 502 sent from the company-B Web service processing apparatus 102 by executing such a process operation similar to the above-explained process steps 2501, 707, 708 in the company-B Web service processing apparatus 102. Then, this produced company-C Web service progress information notification data 902 is notified to the company-B Web service processing apparatus 102 (step 709).

In the progress and historical information receiving unit 210 which has received the company-C Web service progress information notification data 902, this company-C Web service progress information notification data 902 is stored in the company-B Web service progress notification information table 1200. At the same time, the in-service ID 1105 of the company-B Web service progress information request management table 1100 is retrieved so as to specify a progress information notification destination, and then, a judgement is made as to whether or not the progress information notification is permitted in a similar process step to the step 2501 (step 2502).

If the progress information notification is permitted, then such a progress information notification data of FIG. 11 is produced which indicates a change in the progress status in the company-B Web service processing apparatus 102 in a similar manner to the step 707 (step 717). As to the progress information notification data formed in the step 717, the contents thereof are changed in correspondence with the day/time of the information 809, the subject process of the information 810, and the status of the information 811 as to the company-B Web service progress information notification data 801 which has been previously transmitted from the company-B Web service processing apparatus 102 to the company-A Web service processing apparatus 101 in response to the company-C Web service progress information notification data 902, which have been replaced by “2002/8/24 8:00:00”, “basic structural appliance delivery notification accept”, “completion”, and so on.

Then, the company-B Web service progress information notification data formed in the step 717 is transmitted to a notification destination indicated by the progress information notification destination 1101 contained in the company-B Web service progress information request management table 1100 (step 718).

In the progress and history notification receiving unit 204 of the company-A Web service processing apparatus 101, the progress information notification data notified in the step 708 and the step 709 is received, and then, is stored in the company-A Web service progress notification information management table 1300 within the progress and historical information storage area 205.

In the case that the person in charge of the company A confirms a progress condition, the content of the company-A Web service progress/history display unit 206 of the progress and historical information storage area 205 is read by the progress/history display unit 206 of the company-A Web service processing apparatus 101, and then, both the progress information and the historical information are displayed.

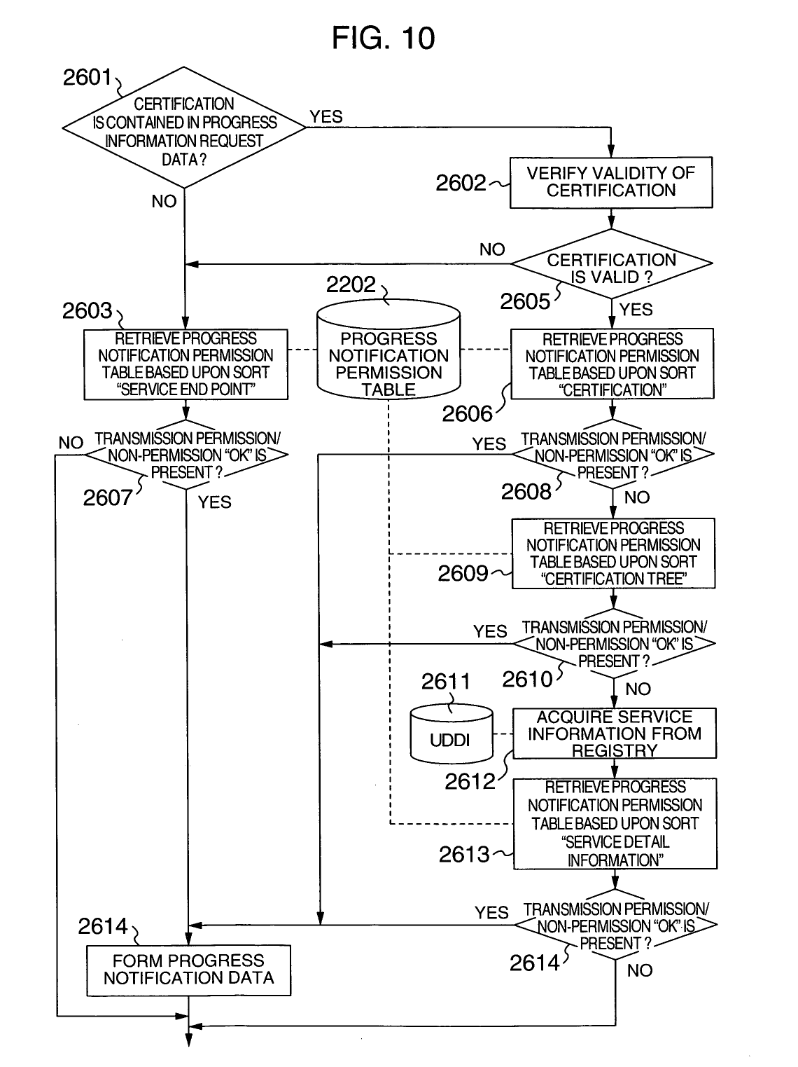

FIG. 10 is a flow chart for indicating detailed contents as to the progress notification permission/non-permission judgeing process operation of the step 2501 of FIG. 9 according to this embodiment. As shown in FIG. 10, in a step 2601, the progress and history notification permission/non-permission judging unit 2201 of the company-B Web service processing apparatus 102 firstly checks as to whether or not a certification is contained in the progress information request data in order to judge as to whether or not the progress notification is permitted. In the case that the certification is not contained, the process operation is advanced to a further step 2603 in order to make a judgment only at an end point of the progress notification destination service.

In the step 2603, the content of the company-B Web service progress notification permission table 2202 stored in the storage apparatus is read out, and then, the retrieving operation is carried out by a sort “service end point.” Concretely speaking, the retrieving operation is carried out from such a column that the sort 2801 of the company-B Web service progress notification permission table 2202 becomes the service end point until such a column that the value 2802 is made coincident with the progress information notification destination contained in the progress information request data, and then, the progress and history notification permission/non-permission judging unit 2201-refers to a transmission permission/non-permission 2803 of this column.

In a step 2607, the progress and history notification permission/non-permission judging unit 2201 checks the result of the retrieving operation, and if the observed transmission permission/non-permission 2803 is “OK”, then this judging unit 2201 judges the transmission permission. The process operation is advanced to a step 2614. In the case that the observed transmission permission/non-permission 2803 is “NG”, or such a column that the value 2802 is made coincident with the progress information notification destination contained in the progress information request data could not be retrieved, the progress and history notification permission/non-permission judging unit 2201 judges that the transmission is not permitted, and thus, accomplishes the progress notification judging process operation.

On the other hand, when the certification is contained in the progress information request data in the process operation of the step 2601, the process operation is firstly advanced to a step 2602. In this step 2602, a check is made as to whether or not this certification becomes invalid so as to verify the validity of the certification.

In a step 2605, when the judging unit 2201 judges that this certification becomes invalid by referring to the verification result of the certification, the process operation is advanced to a step 2603, whereas when the judging unit 2201 judges that this certification becomes valid by referring to the verification result of the certification, the process operation is advanced to a step 2606.

In the step 2606, the company-B Web service progress notification permission table 2202 is retrieved based upon the sort “certification.” Concretely speaking, the retrieving operation is carried out from such a column that the sort 2801 of the company-B Web service progress notification permission table 2202 becomes the certification until such a column that the value 2802 is made coincident with the certification contained in the progress information request data, and then, the progress and history notification permission/non-permission judging unit 2201 refers to a transmission permission/non-permission 2803 of this column.

In a step 2608, the progress and history notification permission/non-permission judging unit 2201 checks the result of the retrieving operation, and if the observed transmission permission/non-permission 2803 is “OK”, then this judging unit 2201 judges the transmission permission. The process operation is advanced to the step 2614. In the case that the observed transmission permission/non-permission 2803 is “NG”, or such a column that the value 2802 is made coincident with the certification contained in the progress information request data could not be retrieved, the process operation is advanced to a step 2609.

In the step 2609, the content of the company-B Web service progress notification permission table 2202 is retrieved based upon the sort “certification tree.” Concretely speaking, a tree of authentication stations is traced from the given certification. Such a retrieving operation is carried out from such a column that the sort 2801 of the company-B Web service progress notification permission table 2202 of FIG. 17 becomes the certification tree up to such a column that the value 2802 is made coincident with any one of the authentication stations within the certification tree traced from the certification, and then, the judging unit 2201 refers to a transmission permission/non-permission 2803 of this column.

In a step 2610, the progress and history notification permission/non-permission judging unit 2201 checks the result of the retrieving operation, and if the observed transmission permission/non-permission 2803 is “OK”, then this judging unit 2201 judges the transmission permission. The process operation is advanced to the step 2614. In the case that the observed transmission permission/non-permission 2803 is “NG”, or such a column that the value 2802 is made coincident with any one of the authentication stations of the certification tree traced from the certification could not be retrieved, the process operation is advanced to a step 2612.

In the step 2612, detailed information of the service is acquired from the UDDI registry apparatus 2611 having the UDDI (Universal Description, Discovery and Integration) registry. In a step 2613, the company-B Web service progress notification permission table 2202 is retrieved based upon the sort “service detailed information.” Concretely speaking, the service detailed information such as a business name, a group name, and a service sort of the progress information notification destination is retrieved from the registry of the UDDI registry apparatus 1611, and the values are stored into variables of Company, Group, and Service. Such a retrieving operation is carried out from such a column that the sort 2801 of the company-B Web service progress notification permission table 2202 becomes the service detailed information up to such a column that the acquired service detailed information can satisfy a condition formula stored in the value 2802, and then, the judging unit 2201 refers to a transmission permission/non-permission 2803 of this column.

In the step 2614, the progress and history notification permission/non-permission judging unit 2201 checks the result of the retrieving operation, and if the observed transmission permission/non-permission 2803 is “OK”, then this judging unit 2201 judges the transmission permission. The process operation is advanced to the step 2614. In the case that the observed transmission permission/non-permission 2803 is “NG”, or such a column that the acquired service detailed information can satisfy the condition formula stored in the value 2802 could not be retrieved, this judging unit 2201 judges that the transmission is not permitted, and thus, accomplishes the progress notification permission/non-permission judging process operation.

As previously described, the progress information request data 402 is set in a similar format as shown in FIG. 6, and since this set progress information request data 402 is combined with the information used to realize the function of the Web service processing apparatus and the combined data is transmitted, the progress information can be notified by way of the data format which is commonly available among the plural Web service processing apparatus even if the interfaces related to the progress information are not separately formed among the respective Web service processing apparatus, but also the process operations specific to the respective Web service processing apparatus are not formed. Since the progress information request is transmitted in combination with the service request used to realize the function of the Web service processing apparatus, the interfaces related to the progress information can be separately determined among the Web service processing apparatus.

As previously explained, in accordance with the service processing apparatus of this embodiment, in such a case that the transmission permission/non-permission information corresponding to the information contained in the progress information request data which has been transmitted in combination with the specification data of the predetermined service indicates that the notifications of the historical information and the progress-information are permitted, since both the historical information and the progress information are transmitted to the progress information notification destination indicated in this progress information request data, when the historical information and the progress information are transmitted in such a case that the process operation for providing a predetermined service is carried out, the transmission range can be restricted to a specific range.

It should be further understood by those skilled in the art that although the foregoing description has been made on embodiments of the invention, the invention is not limited thereto and various changes and modifications may be made without departing from the spirit of the invention and the scope of the appended claims.

1. A service processing method for executing a process operation for providing a predetermined service to transmit historical information and progress information, comprising:
a step by which a message is received by a communication means, while said message contains both specification data used to execute the process operation for providing the predetermined service and progress information request data used to notify the historical information and the progress information of said process operation, and then, the process operation for providing said predetermined service is carried out based upon the specification data contained in said received message;
a step by which progress information request data is read so as to be analyzed from a message stored in a storage means, transmission permission/non-permission information corresponding to information contained in said analyzed progress information request data is read out from said storage means, and then, a judgement is made as to whether or not said historical information and said progress information of said process operation are notified; and
a step by which in such a case that the judgement is made that both the historical information and the progress information are notified, both historical information and progress information are produced on the storage means based upon said progress information request data, and then, both said produced historical information and said produced progress information are transmitted by the communication means to a progress information notification destination indicated in said progress information request data.

2. A service processing method as claimed in claim 1 wherein:
a progress information permission table is read out from the storage means so as to refer to transmission permission/non-permission information; and a judgement is made as to whether or not both the historical information and said progress information of said process operation are notified in response to a content of the transmission permission/non-permission information corresponding to the progress information notification destination contained in said progress information request data.

3. A service processing method as claimed in claim 1 wherein:
a progress information permission table is read out from the storage means so as to refer to transmission permission/non-permission information; and a judgement is made as to whether or not both the historical information and said progress information of said process operation are notified in response to a content of the transmission permission/non-permission information corresponding to a certification contained in said progress information request data.

4. A service processing method as claimed in claim 3 wherein:
validity of the certification contained in said progress information request data is verified; and when said verified certification is validated, the transmission permission/non-permission information corresponding to the certification is read out from the progress notification permission table stored in the storage means.

5. A service processing method as claimed in claim 1 wherein:
a progress notification permission table is read out from the storage means so as to refer to transmission permission/non-permission information; and a judgement is made as to whether or not the historical information and the progress information of said process operation are notified in response to a content of the transmission permission/non-permission information corresponding to a certification tree which has been traced from the certification contained in said progress information request data.

6. A service processing method as claimed in claim 5 wherein:
validity of the certification contained in said progress information request data is verified; and when said verified certification is invalid, a judgement is made as to whether or not the historical information and the progress information of said process operation are notified in response to a content of the transmission permission/non-permission information corresponding to a certification tree which has been traced from the certification.

7. A service processing method as claimed in claim 1 wherein:
detailed information of said predetermined service is received by the communication means from an information processing apparatus which has stored thereinto the information of said predetermined service; a progress information permission table is read out from the storage means so as to refer to transmission permission/non-permission information; and a judgement is made as to whether or not both the historical information and said progress information of said process operation are notified in response to a content of the transmission permission/non-permission information corresponding to the detailed information of said received service.

8. A service processing method as claimed in claim 7 wherein:
in such a case that the notification of said progress information of the processing operation is not permitted even in the transmission permission/non-permission information of any of the progress information notification destination, the certification, and the certification tree, which are contained in said progress information request data, a judgement is made as to whether or not the historical information and the progress information of said processing operation are notified in response to a content of the transmission permission/non-permission information corresponding to the detailed information of the service received by said communication means.

9. A service processing apparatus for executing a process operation for providing a predetermined service to transmit historical information and progress information, comprising:
a service providing unit by which a message is received by a communication means, while said message contains both specification data used to execute the process operation for providing the predetermined service and progress information request data used to notify the historical information and the progress information of said process operation, and then, the process operation for providing said predetermined service is carried out based upon the specification data contained in said received message;
a notification permission/non-permission judging unit by which progress information request data is read so as to be analyzed from a message stored in a storage means, transmission permission/non-permission information corresponding to information contained in said analyzed progress information request data is read out from said storage means, and then, a judgement is made as to whether or not said historical information and said progress information of said process operation are notified; and a notification information transmitting unit by which in such a case that the judgement is made that both the historical information and the progress information are notified, both historical information and progress information are produced on the storage means based upon said progress information request data, and then, both said produced historical information and said produced progress information are transmitted by the communication means to a progress information notification destination indicated in said progress information request data.

10. A program for causing a computer to execute a service processing method for executing a process operation for providing a predetermined service to transmit historical information and progress information, wherein; said service processing method is comprised of:
a step by which a message is received by a communication means, while said message contains both specification data used to execute the process operation for providing the predetermined service and progress information request data used to notify the historical information and the progress information of said process operation, and then, the process operation for providing said predetermined service is carried out based upon the specification data contained in said received message;
a step by which progress information request data is read so as to be analyzed from a message stored in a storage means, transmission permission/non-permission information corresponding to information contained in said analyzed progress information request data is read out from said storage means, and then, a judgement is made as to whether or not said historical information and said progress information of said process operation are notified; and
a step by which in such a case that the judgement is made that both the historical information and the progress information are notified, both historical information and progress information are produced on the storage means based upon said progress information request data, and then, both said produced historical information and said produced progress information are transmitted by the communication means to a progress information notification destination indicated in said progress information request data.

11. A service processing method as claimed in claim 2 wherein:
a progress information permission table is read out from the storage means so as to refer to transmission permission/non-permission information; and a judgement is made as to whether or not both the historical information and said progress information of said process operation are notified in response to a content of the transmission permission/non-permission information corresponding to a certification contained in said progress information request data.

12. A service processing method comprising steps of:
receiving a message including both a specification data used to execute a service providing process and a progress information request data used to transmit a historical information and a progress information as to the process operation;
judging whether there is an information on a transmission of the historical information and the progress information with reading the progress information request data;
generating both the historical information and the progress information in accordance with the progress information request data in case that there is the information on the transmission; and
transmitting both the historical information and the progress information toward a transmission destination defined in the progress information request data.
